(19) United States
(12) Patent Application Publication
(10) Pub. No.: US 2024/0106167 A1
(43) Pub. Date: Mar. 28, 2024

(54) Connector and Method of Fastening Wires to the Connector

(71) Applicants: Hyundai Motor Company, Seoul (KR); Kia Corporation, Seoul (KR); Korea Electric Terminal Co., Ltd., Incheon (KR); THN Corporation, Daegu (KR)

(72) Inventors: Min Jae Kim, Hwaseong-si (KR); Jung Jae Lee, Bucheon-si (KR); Dong Bang Kim, Cheongju-si (KR); Seongdae Shin, Suwon-si (KR)

(21) Appl. No.: 18/335,361

(22) Filed: Jun. 15, 2023

(30) Foreign Application Priority Data
Sep. 28, 2022 (KR) 10-2022-0123362

(51) Int. Cl. H01R 13/639; H01R 13/514; H01R 13/627

(52) U.S. Cl. CPC H01R 13/639; H01R 13/514; H01R 13/6273; H01R 2107/00

(57) ABSTRACT

An embodiment connector includes a first housing including a first insertion hole configured to receive a first wire having a first diameter and a through-hole and a second housing having a size corresponding to the through-hole of the first housing, the second housing including a second insertion hole configured to receive a second wire having a second diameter smaller than the first diameter, wherein the second housing is configured to be inserted into the through-hole before assembly to the first housing.

### CROSS-REFERENCE TO RELATED APPLICATIONS

This application claims the benefit of Korean Patent Application No. 10-2022-0123362, filed on Sep. 28, 2022, which application is hereby incorporated herein by reference.

### TECHNICAL FIELD

The present disclosure relates to a connector and a method of fastening wires to the connector.

### BACKGROUND

Generally, when connecting wires to a connector, a method of inserting wires into a plurality of insertion holes of the connector is mainly used.

However, in the case of a multipole connector to which a plurality of wires of various diameters are fastened, a plurality of wires pre-connected to a connector may interfere with an inserting of wires connected later to the connector, and narrow wires having a small diameter may be easily buckled in the process of being inserted into a plurality of insertion holes, so that it is not easy to improve the connection between wires and connector.

### SUMMARY

An embodiment of the disclosure provides a connector capable of easily performing fastening work of wires having various diameters and a method of fastening the wires to the connector.

Further, another embodiment of the disclosure provides a connector capable of effectively suppressing buckling of a narrow wire having a small diameter during the fastening process and a method of fastening the wires to the connector.

Additional embodiments of the disclosure will be set forth in part in the description which follows and, in part, will be obvious from the description or may be learned by practice of the disclosure.

In accordance with an embodiment of the disclosure, a connector includes a first housing including a plurality of first insertion holes into which a first wire having a first diameter is inserted and fastened and a second housing including a plurality of second insertion holes into which a second wire having a second diameter smaller than the first diameter is inserted and fastened, wherein the first housing includes a through-hole corresponding to a size of the second housing, and the second housing is inserted into the through-hole and assembled to the first housing.

The through-hole may penetrate the first housing in a thickness direction thereof so that the second housing is assembled to the first housing along the thickness direction thereof, and the first and second insertion holes may penetrate the first and second housings along the thickness direction of the first housing, respectively.

A length of the second insertion hole may be shorter than that of the first insertion hole.

The first housing may be coupled with an anti-separation member configured to prevent the first wire from being separated from the first insertion hole, and a coupling portion may be provided between the anti-separation member and the second housing to bind the second housing to the anti-separation member.

A first coupling portion may be provided between the first housing and the second housing to bind the second housing inserted into the through-hole to the first housing, an anti-separation member configured to prevent the first wire from being separated from the first insertion hole may be coupled with the first housing, and a second coupling portion may be provided between the anti-separation member and the second housing to bind the second housing to the anti-separation member.

In accordance with another embodiment of the disclosure, a method of fastening wires to a connector by inserting and fastening the wires into the connector is provided, and the method includes inserting and fastening the second wires into the second insertion holes of the second housing and inserting the second housing to which the second wire is fastened into the through-hole to be assembled.

The method may further include inserting and fastening the first wire into the first insertion hole of the first housing in a state in which the second housing is assembled to the through-hole.

The method may further include inserting and fastening the first wire into the first insertion hole of the first housing before the second housing is assembled to the through-hole.

In accordance with another embodiment of the disclosure, a connector includes a first housing including a plurality of first insertion holes to which a first wire having a first diameter is inserted to be fastened and a second housing provided to be assembled with the first housing, the second housing including a plurality of second insertion holes to which a second wire having a second diameter different from the first diameter is inserted to be fastened.

In accordance with another embodiment of the disclosure, a connector includes a plurality of housings each including a plurality of insertion holes into which wires are inserted to be fastened, the plurality of housings assembled together to form one body, wherein each of the plurality of the insertion holes has a size corresponding to the diameter of the wires to be inserted, and the plurality of the insertion holes of at least one of the housings has a different size from the plurality of the insertion holes of the other housings.

One of the plurality of housings may include a through-hole into which the other housing are inserted to be assembled.

The plurality of the insertion holes of the housing having the through-hole may be formed larger than the plurality of the insertion holes of the other housings.

The plurality of housings may include three or more housings, and the through-hole is provided in plurality to allow the other housings to be individually inserted to be assembled.

The plurality of housings may include three or more housings, and the other housings in a state of being assembled together to form one body are integrally inserted into and assembled to the through-hole provided on one housing of the plurality of housings.

The plurality of the insertion holes formed in each of the housings may have different sizes so that the wires having different diameters are fastened to the plurality of housings.

### BRIEF DESCRIPTION OF THE DRAWINGS

These and/or other aspects of embodiments of the disclosure will become apparent and more readily appreciated from the following description of the embodiments, taken in conjunction with the accompanying drawings, in which:

FIG. 1 is an exploded view illustrating a connector according to an exemplary embodiment of the disclosure;

FIG. 2 is a view illustrating a state in which a second wire is fastened to a second housing of a connector according to an exemplary embodiment of the disclosure;

FIG. 3 is a view illustrating a state in which the second housing of FIG. 2 is assembled to a first housing;

FIG. 4 is a view illustrating a state in which the second wire is fastened to the first housing of FIG. 3;

FIG. 5 is a cross-sectional view illustrating a main part of a connector according to an exemplary embodiment of the disclosure, showing a state in which fastening of a first wire and a second wire is completed;

FIG. 6 shows a modified example of a connector according to an exemplary embodiment of the disclosure; and

FIG. 7 shows another modified example of a connector according to an exemplary embodiment of the disclosure.

### DETAILED DESCRIPTION OF ILLUSTRATIVE EMBODIMENTS

Reference will now be made in detail to the embodiments of the disclosure, examples of which are illustrated in the accompanying drawings, wherein like reference numerals refer to like elements throughout. This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘parts’, ‘modules’, ‘members’, ‘blocks’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, embodiments of the disclosure will be described in detail with reference to the accompanying drawings.

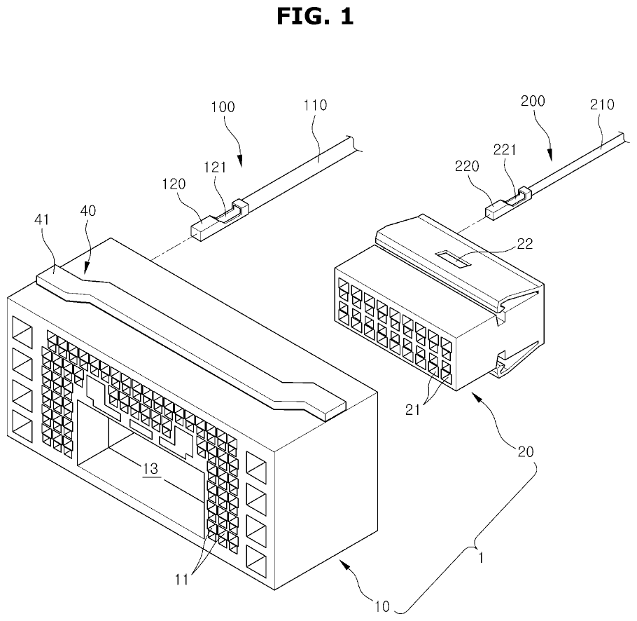

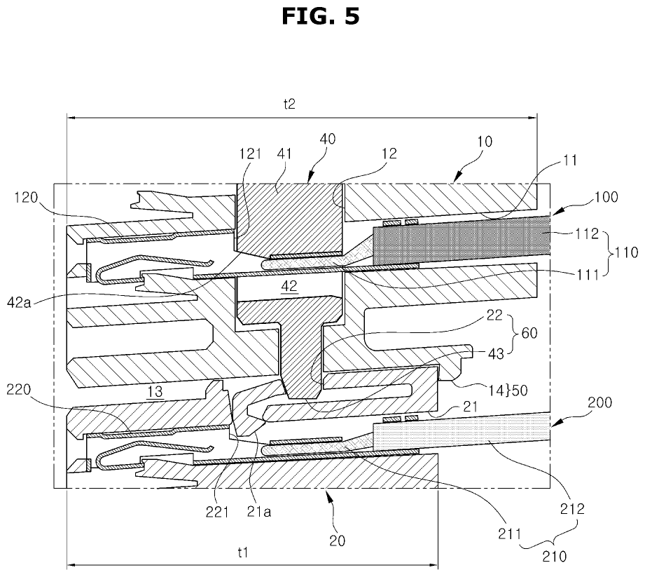

As shown in FIGS. 1 to 5, a connector 1 according to an exemplary embodiment includes a first housing 10 and a second housing 20 and may be provided in a split type.

The first housing 10 may include a plurality of first insertion holes 11 into which a first wire 100 is inserted and fastened, and the second housing 20 may include a plurality of second insertion holes 21 into which a second wire 200 is inserted and fastened.

The first insertion holes 11 may be formed to pass through the first housing 10, and the second insertion holes 21 may be formed to pass through the second housing 20. The plurality of first and second insertion holes 11 and 21 may be arranged in the first and second housings 10 and 20 in a lattice shape, respectively.

The first wire 100 may have a first diameter, and the second wire 200 may have a second diameter smaller than the first diameter. The second wire 200 may be a narrower wire, and the first wire 100 may be a normal wire having a relatively larger diameter than the second wire 200. The second wire 200 may be 0.13 Square (SQ) or less.

The wires 100 and 200 may include wire portions 110 and 210, including core wires in and 211 and sheaths 112 and 212, and terminal portions 120 and 220 coupled to the wire portions 110 and 210. The terminal portions 120 and 220 are coupled to the core wires in and 211 at the tips of the wire portions 110 and 210 from which the sheaths 112 and 212 are removed. The wires 100 and 200 are inserted into the insertion holes 11 and 21 through the terminal portions 120 and 220 and the wire portions 110 and 210 adjacent to the terminal portions 120 and 220. The wires 100 and 200 inserted into the insertion holes 11 and 21 may be connected to the connector 1 through the terminal portions 120 and 220.

The first housing 10 may be coupled with an anti-separation member 40 preventing the first wire 100 from being separated from the first insertion holes 11.

The first wire 100 is inserted into the first insertion holes 11 from a rear of the first housing 10 to a front thereof along a thickness direction of the first housing 10, and the anti-separation member 40 may be coupled with the first housing 10 from the outer side of a top of the first housing 10 to the inside of the first housing 10.

The anti-separation member 40 includes a body 41, and a coupling groove 12 for coupling the body 41 may be provided between front and rear surfaces of the first housing 10. The coupling groove 12 may be formed along a height direction of the first housing 10 so as to be opened toward the top of the first housing 10 and may intersect with the plurality of first insertion holes 11. An upper portion of the body 41 may be exposed to the top of the first housing while being coupled to the coupling groove 12.

The body 41 is provided with a communication hole 42 communicating with the first insertion holes 11 of the first housing 10, and the communication hole 42 may be provided in plurality. The communication holes 42 may communicate with the first insertion holes 11 in a state in which the body 41 of the anti-separation member 40 is coupled to the first housing 10. The terminal portion 120 of the first wire 100 is provided with a locking groove 121, and an inner circumference of the communication holes 42 may be provided with a locking protrusion 42a to be caught in the locking groove 121.

The first wire 100 is inserted into the first insertion hole 11 in a state in which the anti-separation member 40 is coupled to the first housing 10. Accordingly, the first wire 100 inserted into the first insertion hole 11 is prevented from being separated from the first insertion hole 11 while the locking groove 121 is caught in the locking protrusion 42a, thereby being fixed to the first housing 10.

For reference, the terminal portion 220 of the second wire 200 is provided with a locking groove 221, and the inner surface of the second insertion hole 21 is provided with a locking protrusion 21a so as to be caught in the locking groove 221, so that the second wire 200 inserted into the insertion hole 21 may be fixed to the second insertion hole 21.

In addition, to increase workability of fastening wires to the connector 1, the first housing 10 and the second housing 20 may be assembled with each other.

For example, the first housing 10 may include a through-hole 13 corresponding to the size of the second housing 20, and the second housing 20 may be inserted into the through-hole 13 to be assembled.

In the structure in which the second housing 20 is assembled to the first housing 10 through the through-hole 13, the entire perimeter of the second housing 20 may be supported through the first housing 10. Accordingly, the connector 1 in which the first housing 10 and the second housing 20 are provided in a split type may maintain a more stable assembly structure in a state in which the first and second housings are assembled.

According to the assembly structure of the first housing 10 and the second housing 20 above described, the narrower second wire 200 is inserted into the second insertion hole 21 of the second housing 20 in a state of being separated from the first housing 10, and then, the second housing 20 into which the second wire 200 is inserted may be assembled to the first housing 10 through the through-hole 13 of the first housing 10.

Accordingly, the connector 1 separates the first wire wo and the second wire 200 so that they may be inserted into the insertion holes 11 and 21, respectively, so that the connector 1 may prevent the first wire 100 and the second wire 200 from interfering with each other in the process of being fastened to the corresponding insertion holes 11 and 21.

In addition, according to the structure in which the first wire wo and the second wire 200 having different diameters are separated from each other and fastened to the corresponding insertion holes 11 and 21, respectively, the second wire 200 having a small diameter may more effectively suppress buckling in the process of being inserted into the second insertion hole 21. As a result, it is possible to effectively prevent loss of transmission characteristics or durability while the thinned wire is buckled.

Because the through-hole 13 is formed to penetrate the first housing 10 in the thickness direction thereof, the second housing 20 may be assembled to the first housing 10 in the thickness direction of the first housing 10 and each of the first and second insertion holes 11 and 21 may be provided to penetrate the first housing 10 and the second housing 20 in the thickness direction of the first housing 10.

Accordingly, the connector 1 may improve fastening workability of the wires while maintaining the wiring structure of a general connector in which the first and second wires wo and 200 are wired in the same direction.

In addition, a length t1 of the second insertion hole 21 may be shorter than a length t2 of the first insertion hole 11. Accordingly, the connector 1 allows the insertion length of the second wire 200 inserted into the second insertion hole 21 to be relatively shorter than the insertion length of the first wire 100 inserted into the first insertion hole 11, leading to reducing a buckling occurrence range of the second wire 200, which is more vulnerable to buckling than the first wire 100.

To this end, the length of the second housing 20 may be shorter than that of the first housing 10 in the thickness direction of the first housing 10. The connector 1 in which the first housing 10 and the second housing 20 are provided in a split type may be advantageous in that the second housing 20 has a shorter length than the first housing 10, in the process of manufacturing the separately manufactured housings 10 and 20.

In addition, a first coupling portion 50 may be provided between the first housing 10 and the second housing 20 to bind the second housing 20 inserted into the through-hole 13 to the first housing 10, and a second coupling portion 60 may be provided between the anti-separation member 40 and the second housing 20 to bind the second housing 20 to the anti-separation member 40.

The first coupling portion 50 may include a protrusion 14 protruding and extending from the first housing 10 so that a rear surface of the second housing 20 inserted into the through-hole 13 is caught and supported.

The protrusion 14 is formed to protrude shortly from an inner upper surface of the through-hole 13 to allow the second housing 20 to be inserted into the through-hole 13, and supports the rear surface of the second housing 20 when the insertion of the second housing 20 into the through-hole 13 is completed, thereby preventing the second housing 20 from being separated from the through-hole 13.

The second coupling portion 60 may include a locking portion 43 formed to extend into the through-hole 13 in the body 41 of the anti-separation member 40 and a locking groove 22 provided on the outer surface of the second housing 20 so that the locking portion 43 may be caught by the second housing 20.

The locking portion 43 may extend toward the inside of an upper portion of the through-hole 13, and the locking groove 22 may be provided on an upper surface of the second housing 20 facing the inner upper surface of the through-hole 13.

The locking portion 43 may be positioned inside the through-hole 13 when the body 41 is coupled to the coupling groove 12. The locking portion 43 is inserted and caught in the locking groove 22 in the process of inserting the second housing 20 into the through-hole 13, thereby binding the second housing 20 to the anti-separation member 40 coupled to the first housing 10.

As such, because the connector 1 having the first and second coupling portions 50 and 60 is provided in a split type by doubly binding the second housing 20 to the first housing 10, the first housing 10 and the second housing 20 provided in a split type may have sufficient assembly strength in a mutually assembled state.

For reference, any one of the locking protrusion 42a and the locking portion 43 may refer to a first locking portion, and the other may refer to a second locking portion. Likewise, any one of the locking groove 121 and the locking groove 22 may refer to a first locking groove, and the other may refer to a second locking groove.

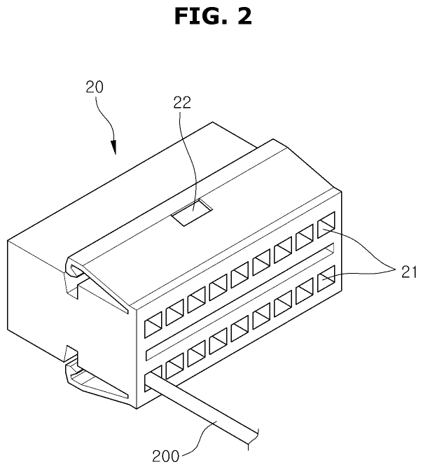

Next, a method of connecting the wires to the connector according to an exemplary embodiment of the disclosure will be described. FIGS. 2 to 4 show a process of fastening the first and second wires 100 and 200 to the connector 1 in sequence.

In order to fasten the wires to the connector 1, as shown in FIG. 2, the second wire 200 is inserted into and fastened to the second insertion hole 21 of the second housing 20 before the second housing 20 is assembled to the first housing 10. At this time, the second wires 200 may be inserted into and fastened to the second insertion hole 21 without interfering with the first wire 100.

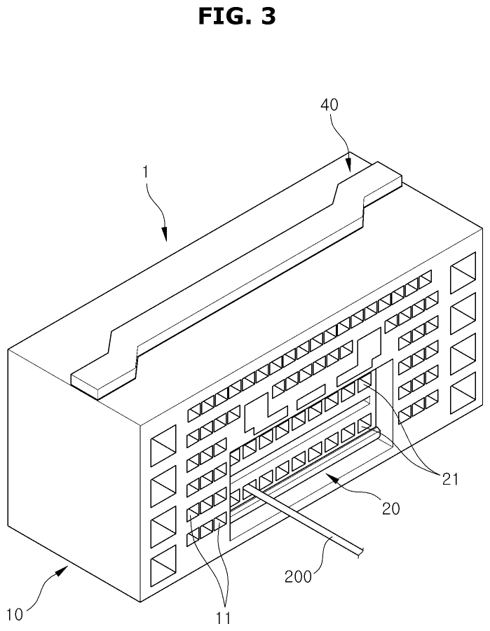

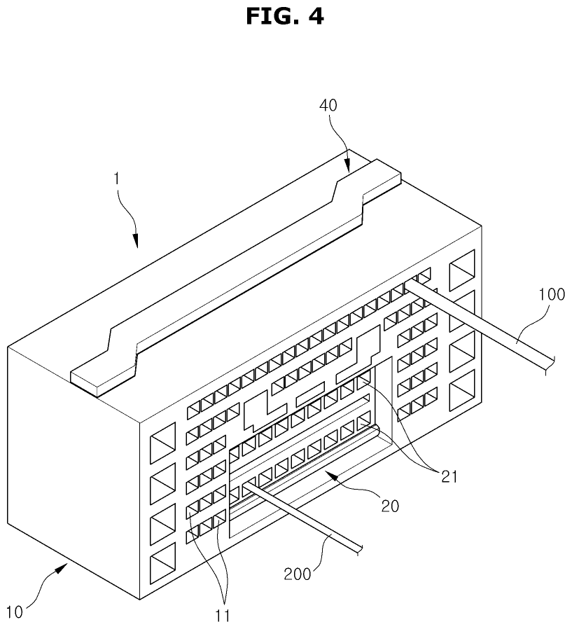

Next, as shown in FIGS. 3 and 4, the second housing 20 to which the second wires 200 are fastened is inserted into the through-hole 13 of the first housing 10 to be assembled, and in this state, the first wires 100 may be inserted into the first insertion hole 11 of the first housing 10 and fastened thereto. At this time, the first wires wo may be smoothly inserted into and fastened to the first insertion hole 11 located around the second housing 20 in a state in which interference by the second wire 200 is suppressed.

The process of inserting and fastening the first wires 100 into the first insertion holes 11 of the first housing 10 may be performed before the second housing 20 is assembled to the through-hole 13. Also, at this time, the first wires 100 and the second wires 200 may be fastened to the connector 1 in a state in which mutual interference is suppressed in a state separated from each other.

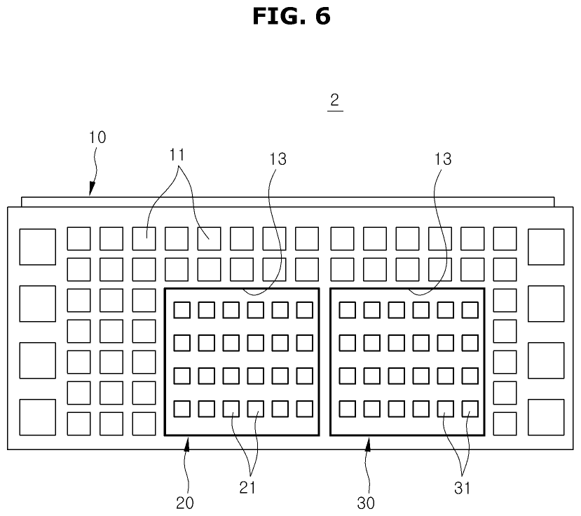

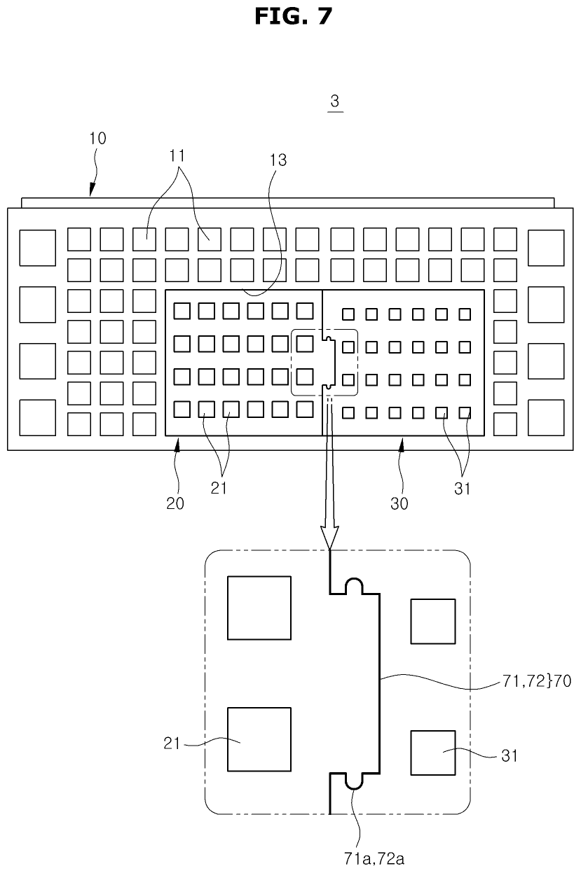

On the other hand, as shown in FIGS. 6 and 7, connectors 2 and 3 according to modified examples of an exemplary embodiment are illustrated.

As shown in FIGS. 6 and 7, the connectors 2 and 3 may be provided in a split type having three or more housings 10, 20, and 30.

The plurality of housings 10, 20, and 30 may include the first housing 10 having a plurality of first insertion holes 11, the second housing 20 having a plurality of second insertion holes 21, and a third housing 30 having a plurality of third insertion holes 31.

The first to third insertion holes 11, 21, and 31 have a size corresponding to the diameter of the wire to be inserted and fastened therein, and the second and third housings 20 and 30 may be assembled to the first housing 10 in a state in which corresponding wires are fastened thereto.

The insertion holes 11, 21, and 31 of at least one of the plurality of housings 10, 20, and 30 may have a different size from the insertion holes of the other housings. Accordingly, the wires may be fastened to the connector 1 in a state where the wires having different diameters are identified.

The first housing 10 may have the through-hole 13, and the second and third housings 20 and 30 may be inserted into the through-hole 13 and assembled to the first housing 10. Accordingly, the wires that are fastened to the second and third housings 20 and 30 and the wires fastened to the first housing 10 may not interfere with each other.

The first insertion holes 11 of the first housing 10 may be larger than the second and third insertion holes 21 and 31 of the second and third housings 20 and 30 so that the wires having a larger diameter may be fastened to the first housing 10. Accordingly, the connectors 2 and 3 allow the narrower (or thinner) wires to be fastened to the second housing 20 or the third housing 30 through the second insertion holes 21 or the third insertion holes 31. As a result, it is possible to effectively suppress buckling of the wires in the process of the narrower wires being fastened to the connectors 2 and 3.

The second insertion holes 21 and the third insertion holes 31 may have the same size so that the wires having the same diameter are fastened thereto.

Furthermore, the second insertion holes 21 and the third insertion holes 31 are provided with different sizes so that the wires having different diameters may be separately fastened to the first to third insertion holes 11, 21, and 31. In other words, the wire having a larger diameter than the other wire may be fastened to either one of the second insertion holes 21 and the third insertion holes 31, and the other wire may be fastened to the remaining holes.

As shown in FIG. 6, the plurality of through-holes 13 are formed in the first housing 10, and the second and third housings 20 and 30 may be inserted into and fastened to each of the through-holes 13.

In addition, as shown in FIG. 7, the through-hole 13 is provided to correspond to the sum of the sizes of the second and third housings 20 and 30, and in the through-hole 13, the second and third housings 20 and 30 may be integrally inserted and assembled in an assembled state to form one body.

For the connector 3, a coupling portion 70 may be provided between the second housing 20 and the third housing 30 to couple therebetween.

The coupling portion 70 may include a protrusion 71 protruding from one side of the second housing 20 and the third housing 30 to the other side and a groove 72 formed on the other side so that the protrusion 71 is inserted.

A restraining protrusion 71a and a restraining groove 72a may be provided between an outer surface of the protrusion 71 and an inner surface of the groove 72 so that the protrusion 71 is restrained to the groove 72 while being inserted into the groove 72.

As is apparent from the above, various embodiments of the disclosure may provide the connector and the method of fastening wires to the connector that may easily perform fastening work of the wires having various diameters.

Further, various embodiments of the disclosure may provide the connector and the method of fastening wires to the connector capable of effectively suppressing the buckling of a narrow wire having a small diameter during the fastening process.

Although embodiments of the disclosure have been shown and described, it would be appreciated by those having ordinary skill in the art that changes may be made in these embodiments without departing from the principles and spirit of the disclosure, the scope of which is defined in the claims and their equivalents.

What is claimed is:

1. A connector comprising:
a first housing comprising:
a first insertion hole configured to receive a first wire having a first diameter, and
a through-hole; and
a second housing having a size corresponding to the through-hole of the first housing, the second housing comprising a second insertion hole configured to receive a second wire having a second diameter smaller than the first diameter, wherein the second housing is configured to be inserted into the through-hole for assembly to the first housing.

2. The connector of claim 1, wherein:
the through-hole penetrates the first housing in a thickness direction of the first housing so that the second housing is assembled to the first housing along the thickness direction of the first housing; and
the first and second insertion holes respectively penetrate the first and second housings along the thickness direction of the first housing.

3. The connector of claim 1, wherein a length of the second insertion hole is shorter than a length of the first insertion hole.

4. The connector of claim 1, wherein:
the first housing is coupled with an anti-separation member configured to prevent the first wire from being separated from the first insertion hole; and
a coupling portion is provided between the anti-separation member and the second housing to bind the second housing to the anti-separation member.

5. The connector of claim 1, further comprising:
a first coupling portion provided between the first housing and the second housing and configured to bind the second housing inserted into the through-hole to the first housing;
an anti-separation member coupled with the first housing and configured to prevent the first wire from being separated from the first insertion hole; and
a second coupling portion provided between the anti-separation member and the second housing and configured to bind the second housing to the anti-separation member.

6. A method of fastening the first and second wires to the connector of claim 1, the method comprising:
inserting and fastening the second wire into the second insertion hole of the second housing; and
inserting the second housing to which the second wire is fastened into the through-hole of the first housing to be assembled.

7. The method of claim 6, further comprising inserting and fastening the first wire into the first insertion hole of the first housing in a state in which the second housing is in the through-hole and assembled to the first housing.

8. The method of claim 6, further comprising inserting and fastening the first wire into the first insertion hole of the first housing before the second housing is inserted into the through-hole and assembled to the first housing.

9. A connector comprising:
a first housing comprising a plurality of first insertion holes configured to receive and fasten a plurality of first wires each having a first diameter; and
a second housing configured to be assembled with the first housing, the second housing comprising a plurality of second insertion holes configured to receive and fasten a plurality of second wires each having a second diameter different from the first diameter.

10. The connector of claim 9, wherein a length of the second insertion holes is shorter than a length of the first insertion holes.

11. The connector of claim 9, wherein:
the first housing is coupled with an anti-separation member configured to prevent the plurality of first wires from being separated from the plurality of first insertion holes; and
a coupling portion is provided between the anti-separation member and the second housing to bind the second housing to the anti-separation member.

12. The connector of claim 9, further comprising:
a first coupling portion provided between the first housing and the second housing and configured to bind the second housing to the first housing;
an anti-separation member coupled with the first housing and configured to prevent the plurality of first wires from being separated from the plurality of first insertion holes; and
a second coupling portion provided between the anti-separation member and the second housing and configured to bind the second housing to the anti-separation member.

13. A connector comprising:
a plurality of housings each including a plurality of insertion holes configured to receive and fasten a plurality of wires, the plurality of housings configured to be assembled together to form one body;
wherein each of the insertion holes has a size corresponding to a diameter of the wire to be received; and
wherein the insertion holes of one housing of the plurality of housings have a different size from the insertion holes of another housing of the plurality of housings.

14. The connector of claim 13, wherein a first housing of the plurality of housings comprises a through-hole into which remaining housings of the plurality of housings are configured to be inserted for assembly.

15. The connector of claim 14, wherein the insertion holes of the first housing are larger than the insertion holes of the remaining housings.

16. The connector of claim 14, wherein:
the plurality of housings comprises three or more housings; and
the through-hole comprises a plurality of through-holes to allow the remaining housings to be individually inserted in the first housing to be assembled.

17. The connector of claim 14, wherein:
the plurality of housings comprises three or more housings; and
the remaining housings, in a state of being assembled together to form the one body, are integrally inserted into and assembled to the through-hole provided in the first housing of the plurality of housings.

18. The connector of claim 14, wherein the insertion holes in a first housing of the plurality of housings have a first size and the insertion holes in a second housing of the plurality of housings have a second size different from the first size.

19. The connector of claim 18, wherein first wires of the plurality of wires have a first diameter and are configured to be received in the insertion holes of the first housing, and wherein second wires of the plurality of wires have a second diameter and are configured to be received in the insertion holes of the second housing.

20. The connector of claim 19, wherein a length of the insertion holes of the second housing is shorter than a length of the insertion hole of the first housing.
